(19) United States
(12) Patent Application Publication
(10) Pub. No.: US 2005/0277710 A1
(43) Pub. Date: Dec. 15, 2005

(54) Tagged resin, method of making a tagged resin, and articles made therefrom

(76) Inventors: Richard P. Joyce, Wynantskill, NY (US); Bimal R. Patel, Selkirk, NY (US); Philippe Schottland, Evansville, IN (US)

Correspondence Address: CANTOR COLBURN, LLP, 55 GRIFFIN ROAD SOUTH, BLOOMFIELD, CT, 06002, US

(21) Appl. No.: 10/867,309

(22) Filed: Jun. 14, 2004

(51) Int. Cl. C08K 9/10

(52) U.S. Cl. 523/210

(57) ABSTRACT

One embodiment of a tagged resin comprises: a thermoplastic material and a marked particle. The marked particle comprises a covert identifier, and the particle has an aspect ratio of about 1:1 to about 10:1. One embodiment of the method for making a tagged item comprises: processing a thermoplastic material and a marked particle comprising a covert identifier, to form a processed item. The processing is selected from the group consisting of extruding, injection-molding, masterbatching, masterblending, thermoforming, blow-molding, and combinations comprising at least one of the foregoing processing. The marked particles in the processed item comprise an aspect ratio of about 1:1 to about 10:1.

### BACKGROUND

This disclosure relates to a method of tagging resins, and to compositions and articles produced therefrom the tagged resins.

A major problem confronting the various makers and users of products made from resins (thermoplastic, thermoset, etc.) such as telecommunication products, consumer electronic products, automotive parts, medical devices or containers, identification documents (e.g., identity (ID) cards), and credit cards, has been the unauthorized reproduction or copying of such products or articles by unauthorized manufacturers, sellers, and/or users. Such unauthorized reproduction is often referred to as piracy and can occur in a variety of ways, including consumer level piracy at the point of end use as well as wholesale duplication at the commercial level. Regardless of the manner, piracy deprives legitimate manufacturers of significant revenue and profit. In addition, in many cases, piracy is associated with manufacturer liability. In fact, piracy could tarnish the image of a brand by associating defective counterfeit products with reputable companies.

Attempts to stop piracy at the consumer level have included the placement of electronic anti-piracy signals on information carrying substrates along with the article sought to be protected. Theoretically, consumer level duplications are unable to reproduce these electronic anti-piracy signals on unauthorized copies and hence result in duplicates and copies that can be identified. However, numerous technologies to thwart such consumer level anti-piracy technologies have been and continue to be developed. Moreover, commercial level duplications have evolved to the point that unauthorized duplicates now contain the original electronic anti-piracy circuit, code, etc. For example, commercial level duplication methods include hologram or radio frequency (RF) copying.

Automated identification of plastic compositions is very desirable for a variety of applications, such as recycling, tracking the manufacturing source, antipiracy protection, and others. A variety of identification methods of plastic compositions are known, including X-ray (U.S. Pat. No. 5,314,072) and infrared spectroscopy (U.S. Pat. No. 5,510,619). The use of UV and near-IR fluorescent dyes have also been added to polymers for identification purposes (U.S. Pat. Nos. 4,238,524; 5,005,873; 5,201,921; 5,703,229; and 5,553,714). Color-shifting (or interference) pigments are being used in currencies as one of the security layers. However their overt nature limits the operating color space of the plastic composition and significantly increases the cost of the composition.

There accordingly remains a need in the art for lower cost authentication of plastic compositions and articles.

### SUMMARY

Disclosed herein are tagged resin, methods of making tagged resin and tagged items, and the resulting tagged resin and tagged items. One embodiment of a tagged resin comprises: a thermoplastic material and a marked particle. The marked particle comprises a covert identifier and the particle has an aspect ratio of about 1:1 to about 10:1.

One embodiment of the method for making a tagged item comprises processing a thermoplastic material and the marked particle to form a processed item. The processing is selected from the group consisting of extruding, injection-molding, masterbatching, masterblending, thermoforming, blow-molding, and combinations comprising at least one of the foregoing processing. The marked particles in the processed item comprise an aspect ratio of about 1:1 to about 10:1.

The above described and other features are exemplified by the following detailed description and accompanying drawings.

### BRIEF DESCRIPTION OF THE DRAWINGS

Refer now to the figures, which are exemplary, not limiting.

FIG. 1 is a schematic illustration of one embodiment for making marked particles.

FIG. 2 is a micrograph of one embodiment of square, die-cut, micro-embossed flakes.

FIG. 3 is a micrograph of one embodiment of hexagonal, die-cut, micro-embossed flakes.

FIG. 4 is a pictorial representation of one embodiment of a hexagonal part with ball-milled non-embossed flakes.

FIG. 5 is a pictorial representation of one embodiment of a hexagonal three-dimensional part with micro-embossed flakes.

FIG. 6 is a micrograph of a micro-embossed flake from the part of FIG. 5 where the resin and flake were fed through the throat of an extruder.

FIG. 7 is a micrograph of one embodiment of a downstream fed, micro-embossed flake.

FIG. 8 is a micrograph of one embodiment of a rectangular part containing micro-embossed flakes with a fluorophore, taken under standard lighting conditions.

FIG. 9 is a micrograph of the micro-embossed flake of the rectangular part of FIG. 8, taken under UV light.

### DETAILED DESCRIPTION

The disclosed method of tagging plastic resin and articles with particles bearing features forms a security signature that remains detectable in an extruded items (e.g., sheets, films, pellets, tubes, fibers, and the like, that have been compounded using an extruder), injection-molded articles, extrusion, thermoforming, or blow-molded articles (such as bottles or containers), and articles that have otherwise been processed under sufficient shear to rub or otherwise remove the identifier(s). The method of tagging presents a lower cost option compared to color-shifting pigments, allows for more customization in terms of color and appearance, and provides a direct way to embed coded or non-coded identifiers into the resin for detection in a pellet form, molded form, or extruded form. It is noted that the terms “first,” “second,” and the like, herein do not denote any amount, order, or importance, but rather are used to distinguish one element from another, and the terms “a” and “an” herein do not denote a limitation of quantity, but rather denote the presence of at least one of the referenced item. Additionally, all ranges disclosed herein are inclusive and combinable (e.g., the ranges of “up to 25 wt %, with 5 wt % to 20 wt % desired,” are inclusive of the endpoints and all intermediate values of the ranges of “5 wt % to 25 wt %,” etc.). As used herein the term “about”, when used in conjunction with a number in a numerical range, is defined being as within one standard deviation of that number.

A problem encountered when attempting to use marked particles (e.g., flakes (e.g., with for instance a square, hexagonal, or rectangular shape), platelets, spheres, cubes, and/or the like) in thermoplastic resin is their exposure to the degree of heat and shear force resulting from extrusion and/or molding of the thermoplastic resin, while marked particles in thermoset resins tend to be exposed to a shear force during some molding processes. For example, use of the marked particles in an extruder and/or injection molding machine (e.g., at temperatures of greater than or equal to about 120° C.). For example, the shear comes from the presence of kneading blocks (KB) and distributive mixing elements (ME) (e.g., mixing elements: ZME, SME, TME, and the like; with SME and TME particularly useful in the present application).

The contact of marked particles with mixing elements of the extruder or with other hard particles present in a composition creates a “rubbing” effect that has the ability to erase the identifier off of the particle. Particles containing a security identifier (e.g., micro-embossed, imprinted, stamped, laser treated, or otherwise marked) can be incorporated into plastic resins using various compounding techniques, including mixing in a resin blend prior to compounding and/or downstream feeding, e.g., of raw particles or of a masterbatch. The present process and marked particles, attains readable marked particle(s) in an article, pellet, or the like, after processing (e.g., extrusion, molding, or the like). For example, the initial marked particles can be marked to a sufficient depth such that the processed marked particles have a marking depth of greater than or equal to 0.05 micrometers, or more specifically, a depth of greater than or equal to about 0.1 micrometers. In one embodiment, the percentage of depth retained (the depth of the processed marked particle to the depth of the initial marked particle) can be greater than or equal to about 50%, or more specifically, greater than or equal to about 70%, and even more specifically, greater than or equal to about 80%.

When the identifiers are employed for security purposes, the identifiers on the particles are invisible to the naked eye (e.g., covert). Typically, a minimum magnification of about 50× (optical and digital magnification combined) is used to retrieve the information on the marked particles. Magnifications of greater than or equal to about 200× can be used, specifically greater than or equal to about 400×. Overt marks, e.g., colors (including mere interference colors), are identifiable without magnification, the use of a special signal, or other assistant, i.e., are visible to the naked eye, and therefore are more easily replicated by counterfeiters and provide little or no security against counterfeiting.

The identifier (e.g., the mark on the particle and/or distinction in the particle), can comprise any size and any geometry that can be authenticated (e.g., manually and/or automatically, optically authenticated; authenticated via a signal, and/or with other assistance). The size of each identifier, which is covert (i.e., is not visible to the naked eye; only identifiable with assistance, e.g., magnification, a special signal, and/or the like) can be selected so that it is compatible with the particle forming process, or specifically, at least one complete identifier fully visible per particle enables accurate authentication. If the particles are formed prior to marking or formed with the marker (e.g., a natural feature, intentional defect, or the like), the size of the identifier is sufficient to enable authentication by a desired method. However, if the particles are formed after the identifier has been disposed on the article from which the particles will be formed, the accuracy and tolerances of the process for forming the particles becomes relevant. Consequently, although the identifier size can be up to about 99% of the marked particle surface size (e.g., using ultra-precise alignment and special cutting tools, which would translate into significant additional cost), a size of less than or equal to about 80% of the marked particle surface size can accommodate current machine tolerances and the like, wherein size of less than or equal to about 50% of the marked particle surface size enable facile particle formation from a micro-embossed foil.

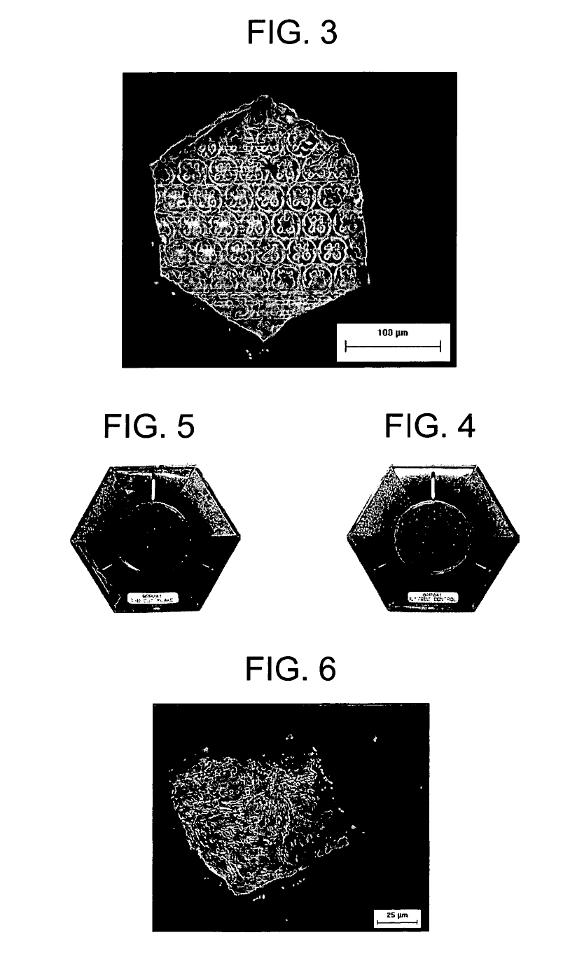

In order to limit the costs associated with the precision cutting tools to a minimum, an identifier size of less than or equal to about 35% of the marked particle surface size can be employed in order to guarantee that at least one full identifier will be present on each particle when the particles are formed, e.g., by cutting of a micro-embossed foil. Optionally, identifiers can be arranged in a pattern, e.g., with minimum spacing between identifiers, in order to guarantee that at least one full identifier will be present per particle, especially if no special high precision alignment technique (such as optical/laser alignment) is used for the cutting process (see for instance, FIGS. 2 and 3).

In an exemplary embodiment, the identifier length (all lengths and widths discussed herein are measured along the major axis (i.e., the longest axis) for the particular dimension, unless otherwise specified) can be less than or equal to about 100 micrometers, or, more specifically, less than or equal to about 50 micrometers, and even more specifically, less than or equal to about 25 micrometers. For example, the identifier, which can comprise lines, curves, fonts, and/or other identifiable features, can have a line width of less than or equal to about 25% of the identifier size, or more specifically, less than or equal to about 10% of the identifier size to enable more accurate authentication. Depending on the technology used to form the identifier, it is possible to dispose forensic identifiers. Covert information can be disposed on the particle, i.e., information that is not visible to the naked eye but is detectable by a microscope. For example, covert information includes information detectable by inspectors in the field, e.g., information detectable at a magnification of about 100× to about 400×. The forensic information (i.e., information that is smaller than the covert information) can be embossed with a smaller size. For example, the forensic information includes information detectable with special equipment, e.g., not detectable by inspectors in the field, but detectable by an ultra high resolution microscope (e.g., a microscope having a resolution of greater than or equal to 500×, a scanning electron microscope (SEM), an atomic force microscope (AFM), or the like) either directly or after isolation of the marked particle. To enhance security, the forensic identifier, which can be designed so as to be unidentifiable in the field, can comprise, for example, signature, special code, or the like. The information can be written (embossed) at a fraction of the logo size (e.g., within a space having a major diameter of about 3 micrometers).

In one embodiment, particles can be marked by first micro-embossing, laser treating (e.g., cutting or the like) a foil (e.g., an inorganic foil, such as an aluminum foil or the like). In one embodiment, for example, a high heat polymer foil (e.g., a foil that would retain its dimensional stability at the processing conditions of the polymer matrix) can be employed. For example, the polymer foil to be micro-embossed could be selected so that its glass transition temperature (Tg) would be higher than the processing temperature (extrusion/molding) of the plastic matrix that will receive the marked particle. Optionally, this polymer foil can be metallized (on one or both sides), e.g., a polyethylene terephthalate (PET) and/or a polyetherimide (PEI) film with a sputtered metal layer such as aluminum, gold, silver, and/or the like.

To enhance readability of the identifier, it can be disposed on (e.g., on/into) a polished surface of the foil/particle. The foil, which can be polished at least on the side to be embossed, has a thickness sufficient to enable the marking process, e.g., a thickness of greater than about 1 micrometer, or more specifically, a thickness of about 1 micrometer to about 75 micrometers, and even more specifically, a thickness of about 10 micrometers to about 40 micrometers. The polish can be to a sufficient degree to attain the desired sparkles or other effects, e.g., a surface roughness Ra of less than or equal to about 0.025 micrometers, or more specifically, less than or equal to about 0.015 micrometers. To attain defined, legible markings on the marked particle, the ratio of surface roughness to marking depth (e.g., embossing depth) can be less than or equal to about 15%, or more specifically, less than or equal to about 10%, even more specifically, less than or equal to about 5%, and even more specifically, less than or equal to about 1%.

As is discussed in greater detail below, additional layer(s) (e.g., protective coating) can be added onto the foil before individual particles are formed, e.g., organic resin layer(s) that can be thermally sealed/laminated, co-extruded, applied as a coating, or otherwise applied to the foil and optionally cross-linked); inorganic layer(s) (e.g., a silica (SiO₂) layer formed for instance by a sol-gel method); and the like, as well as combinations comprising at least one of the foregoing layers. If the layer(s) remain on the processed marked particle, the layer(s) disposed over the identifier(s) is sufficiently transparent to enable authentication of the identifier(s). Examples of additional layers include epoxy resins (e.g., coatings), polyester resins (e.g., heat sealed and/or coextruded layers), as well as combinations comprising at least one of the foregoing. These layers can optionally contain colorants (e.g., pigments), and/or additional security features, such as UV fluorophores (e.g., that will make the identifier detectable under black light). The additional layer(s) can have a thickness that depends on the layer application method. For example, the layer(s) can be about 1 micrometer to about 50 micrometers, or specifically, about 3 micrometers to about 35 micrometers, and more specifically about 5 micrometers to about 20 micrometers.

Once the foil has the optional additional layer(s), individual particles are then formed from the foil, e.g., via a process such as grinding, ball-milling, die-cutting process, and/or a similar process, wherein die-cutting tends to more accurately form the particles with less damage than the other processes. For mechanical integrity and in order to ensure that at least one identifier is present on each particle, a die-cutting process is generally desirable since it allows for a variety of flake shapes with a relatively consistent size and aspect ratio and produces more robust flakes (e.g., more suitable for use in thermoplastic resins) than flakes obtained by grinding. This process also has the advantage of more reproducible particle sizes as well as allowing for a variety of particle shapes (e.g., squares, circles, rectangles, and hexagons, as well as any other shapes) that can, themselves, be an authenticatable feature of the particle(s). In addition, particles obtained using a die-cutting process are typically thicker, enabling of micro-embossing with identifiers on both sides of the particle. Particles with identifiers on both sides enable authentication from either side of the particle. Although more difficult to mark, spherical particles can be particularly useful since they can be marked around the sphere, thereby enabling identification from any angle of the resin or the article.

Although a single particle can be employed to authenticate an item (e.g., resin, article, or the like), multiple authenticable particles enable facile authentication due to ease of locating the identifiable particle in the item. Hence, for facile authentication, sufficient particle dimensional stability to enable a majority of the particles to exhibit at least one complete identifier is generally employed. Hence, particle size and geometry can be chosen based upon sufficient dimensional stability, sufficient thickness to mark, and sufficient size to fit the desired identifier. The aspect ratio (i.e., the ratio of the length of the particle (i.e., the major axis of the article) to the thickness (e.g., width) of the particle (i.e., the longest axis of the particle that is perpendicular to the major axis)) is a factor in whether the particle is robust enough to survive extrusion and molding processes with minimum physical alteration. Sufficient dimensional stability can be obtained with particles (e.g., from a micro-embossed foil) having a median length (i.e., simple average) of about 20 micrometers to about 350 micrometers, or more specifically, about 30 and about 250 micrometers, and even more specifically, about 40 to about 150 micrometers. Typically, the smaller the particle, the more difficult the embossing and the cutting. In particular, the ability to consistently produce particles of less than about 100 micrometers is not common and therefore increases the level of security provided by the marked particles. Consequently, when marked particles for security purposes are formed using a precision cutting method, particles having a median length of about 50 to about 100 micrometers are sought. The particle aspect ratio can be about 1:1 to about 100:1, or more specifically about 1:1 to about 50:1, and even more specifically, about 1:1 to about 10:1. Where the particle size is about 50 micrometers to about 100 micrometers, the aspect ratio can be in about 1:1 to about 5:1. In one embodiment, for reduced possibility of flow lines in the final product and control to ensure the desired marking of the particles, the cut particles can have a desired length chosen to be about 50 to about 100 micrometers are sought

The security identifier can be either coded, non-coded, or a combination of both. Non-coded identifiers include company logos, trademarks, product name, and any other directly readable marking that can be associated with the article, product, resin, supplier, converter, distributor, retailer, end-user, and/or even to a known third party, and the like. An example of non-coded identifier is a GE logo, which people will easily recognize and associate with a product from General Electric Company. Coded identifiers include serial numbers, lot numbers, security codes, and any type of encrypted/coded information that can be traced, e.g., to an authentic lot of resin/product/article, to a specific batch of raw materials used to prepare the resin/product/article, to a specific production date, to a specific retailer/distributor/molder, to a product version, or the like. Optionally, the identifiers on a particle can use different magnifications to be read. For example, the coded identifier (e.g., forensic identifier) can use a higher microscope magnification to be read compared to the non-coded identifier; e.g., the non-coded identifier can be read with a magnification of less than or equal to about 100× for simple authentication, whereas the coded identifier (i.e., forensic tracer) can only be read at a magnification of greater than or equal to about 200× to be retrieved (e.g., 400×). In a particular example, the presence of the coded identifier will not be visible at the magnification at which the non-coded identifier is readable; e.g., a 100× magnification (e.g., a “multilevel identifier”).

Optionally, to enhance the integrity of the particle and/or the identifier on the particle, a protective coating can be used on the particle. For example, at least the identifier can be coated (partially (e.g., at least over the identifier, or wholly), or the particle could be encapsulated within a plastic to form a bead containing the marked particle. The particle can be coated with the protective coating before or after the processing to form the particle (e.g., the foil can be coated with the matrix prior to cutting into the particles), or the particles can be coated once cut. The protective coating may comprise any coating material that has a sufficient amount of transparency and/or translucency to allow the desired optical effect in a plastic product to be achieved. Some non-limiting examples of such materials include those plastics set forth below in relation to the plastic to be tagged. This coating can be deposed on the particles (foil, or the like) using various techniques including painting, laminating, dipping, spraying, plasma deposition, RF sputtering, sol-gel processing, spin coating, and/or the like. In some embodiments, it may be desirable to have a protective coating that comes off or degrades/melts during the extrusion or the molding process, yet still allows for recognition of the identifier in a processed article/pellet. This can provide another level of protection against counterfeiting based on regrind of original parts. Because the coating/protecting layer is no longer present, the regrinding/re-compounding process may damage the particles in a way such that they would have a distinctly different aspect ratio or appearance (e.g., smaller flakes with distorted shape) and damage the identifier; thus allowing easy detection of counterfeit parts.

A cross-linking agent (e.g., divinylbenzene, and the like) can be included in the protective coating. In some embodiments the inclusion of a cross-linking agent may impart mechanical strength and/or melt stability to the coated particles when they are processed in a composition to make a final extruded or molded product. The amount of cross-linking agent that may be incorporated in the encapsulating material is determined by such factors as the physical properties desired in the final product and the compounding conditions used (for example, all-throat feeding vs. down-stream feeding during extrusion), and may be determined without undue experimentation. For example, in some embodiments at the same cross-linker loading, compositions extruded using down-stream feeding may be less ductile than those produced using all-throat feeding. Cross-linking of the protective coating can be performed using various methods capable of initiating cross-linking. Depending on the nature of the cross-linking agent, possible methods include thermal curing, photo curing (e.g., using UV light), radiation curing (e.g., gamma radiation), and the like, as well as combinations comprising at least one of the foregoing methods. In some instances, cross-linking is self-initiated and proceeds without special initiation once the coating components have been mixed (e.g., some epoxy or urethane coatings).

In some embodiments the protective coating may substantially match the refractive index of the plastic in which the coated particles will be disposed (e.g., the plastic matrix). For example, the refractive index difference between the protective coating and the plastic matrix may be less than or equal to about 0.01 to yield a substantially transparent final product (if the plastic matrix itself is substantially transparent and no other pigmentation is added). Alternatively, the refractive index difference between the protective material and the plastic matrix may be about 0.001 to about 0.2, or more specifically, about 0.01 to about 0.1, and even more specifically, about 0.01 to about 0.05, and could even be greater than about 0.2, to yield final products having various degrees of transparency. The desired amount is based upon attaining sufficient transparency to enable authentication of the identifier on the particle.

The encapsulation of the particle may be accomplished in a number of different manners, such as spray drying techniques, the Wurster process (e.g., a Wurster Fluid Bed Coater (commercially available from Lasko Co., Leominster, Mass.; and from Fluid Air, Inc., Aurora, Ill.), in-situ suspension polymerization, and the like. Some possible techniques of coating a particle are disclosed in commonly assigned U.S. patent application Ser. No. 10/351,386, Attorney Docket No. RD29229-1, filed on Jan. 23, 2003. In some embodiments utilizing suspension polymerization, the method may comprise: forming a suspension of the particles and the coating material; optionally sonicating the suspension; adding the suspension to an aqueous mixture comprising a suspension agent to form a reaction mixture; heating and mixing the reaction mixture to encourage the formation of the coated particles; quenching the reaction mixture after the coated particles are formed; and collecting the coated particles (e.g., by gravity sedimentation and/or centrifugation); and drying the particles (actively or passively).

In one embodiment, the gravity sedimentation can comprise: removing from the coated particles the emulsion caused by the suspension polymerization process; filtering the coated particles; reslurrying the coated particles in a salt solution (for example, potassium chloride, or the like) to form a separation system; mixing the separation system; allowing the separation system to come to equilibrium; removing a fraction of useable coated particles from the separation system; filtering the fraction of useable coated particles obtained; washing the filtered fraction to remove any excess slurry solution; adding a quantity of water (e.g., deionized water) to the remaining coated particles to bring the volume of the separation system back to the original volume; and optionally repeating as necessary until a desired percentage of the coated particles have been removed from the separation system.

Optionally, a cross-linking agent may be included in the protective coating to impart mechanical strength and melt stability to the coated particles when they are processed into the final extruded or molded product. The particles may also incorporate surface functionalization thereon, so that growth of the encapsulant polymer is a surface-promoted process. Additionally, compatibilizers (e.g., surface modifiers) can be employed, such as, for example, oleic acid.

Although it is possible to tag any plastic, including amorphous, crystalline, and semi-crystalline resins, amorphous resins are more easily authenticated because light can penetrate through the matrix without being significantly distorted. Transparent resins additionally allow for the authentication of particles more deeply incorporated into the resin and not only those located on the surface or in the outer skin. Examples of possible resins which can be utilized include, but are not limited to, amorphous, crystalline, and semi-crystalline thermoplastic materials: polyvinyl chloride, polyolefins (including, but not limited to, linear and cyclic polyolefins and including polyethylene, chlorinated polyethylene, polypropylene, and the like), polyesters (including, but not limited to, polyethylene terephthalate, polybutylene terephthalate, polycyclohexylmethylene terephthalate, and the like), polyamides, polysulfones (including, but not limited to, hydrogenated polysulfones, and the like), polyimides, polyether imides, polyether sulfones, polyphenylene sulfides, polyether ketones, polyether ether ketones, ABS resins, polystyrenes (including, but not limited to, hydrogenated polystyrenes, syndiotactic and atactic polystyrenes, polycyclohexyl ethylene, styrene-co-acrylonitrile, styrene-co-maleic anhydride, and the like), polybutadiene, polyacrylates (including, but not limited to, polymethylmethacrylate, methyl methacrylate-polyimide copolymers, and the like), polyacrylonitrile, polyacetals, polycarbonates, polyphenylene ethers (including, but not limited to, those derived from 2,6-dimethylphenol and copolymers with 2,3,6-trimethylphenol, and the like), ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, Teflons; as well as thermosetting resins such as epoxy, phenolic, acrylics, alkyds, polyester, polyimide, polyurethane, silicone, bis-maleimides, cyanate esters, vinyl, and benzocyclobutene resins; in addition to copolymers, combinations, reaction products, and composites comprising at least one of the foregoing plastics. Since this process enables the particles to be authenticatable after processing (e.g., extrusion, molding, and the like), the process is particularly useful with plastics where prior particles would have suffered from the rubbing effect. It is noted that opaque or even translucent resins can be employed, but may use a higher loading of marked particles than transparent resins to ensure the ability to easily detect counterfeit molded parts from originals.

Specifically, amorphous polymers with an excellent ductility (e.g., 100% ductility as defined below) at high temperature (e.g., at a temperature of about 23° C.) and preferably even at lower temperatures (e.g., temperatures down to about −20° C. or so) can be employed. Ductility is determined using Notched Izod impact resistance testing according to ASTM D256. As part of the method, the type of failure is reported for each specimen (i.e., complete break, hinge break, partial break, or non-break). A “brittle” break/failure generally corresponds to a complete break/failure as opposed to a “ductile break” (which corresponds to no-break, partial break, or hinge break). Typically, five (5) specimens are tested at the desired temperature (e.g., 23° C., 0° C., −10° C., −20° C., −30° C., −40° C., −50° C.). Percent ductility is defined as the ratio number of “ductile” breaks to the number of tested bars expressed as a percentage. 100% ductility at a given temperature means that a polymer is fully ductile at that temperature. Generally, the testing is performed using 3.2 mm (0.125 inch) thick samples (Notched Izod bars) for the ASTM D256 method. In one embodiment, the polymer matrix (without any additional filler or the marked particles) exhibits 100% ductility at 23° C. In one embodiment, the plastic exhibits 100% ductility at 0° C., or more specifically, 100% ductility at −20° C., and even more specifically, 100% ductility at −40° C., according to ASTM D256 using a 3.2 mm thick sample. Non-limiting examples of such polymers include polycarbonate, polycarbonate-siloxane copolymers, and transparent polycarbonate-polyester blends, as well as combinations comprising at least one of the foregoing polymers, such as Xylex™ polycarbonate/polyester blend (commercially available from GE Plastics, Pittsfield, Mass.). Additionally, the plastic with the marked particles (e.g., tagged plastic resin), can exhibit 100% ductility at 23° C., or more specifically, 100% ductility at 0° C., and even more specifically, greater than or equal to about 40% ductility at −20° C., according to ASTM D256 using a 3.2 mm thick sample.

The plastic may also include various additive(s), filler(s), and/or the like, ordinarily incorporated in plastics of this type, with the proviso that the additives are preferably selected so as to not significantly adversely affect the desired properties of the plastic or the final article. For example, compatabilizer(s), reinforcing agent(s), stabilizer(s) (e.g., heat, light, ultraviolet, and the like), plasticizer(s), antistatic additive(s), antioxidant additive(s), mold release additive(s), lubricant(s), impact modifier(s), flame retardant(s), dye(s), pigment(s), Such additives may be mixed at a suitable time during the mixing of the components for forming the plastic. Because of the potential “rubbing” effect of the marked particles with any additive(s), filler(s) or the like, in one embodiment, the tagged resin has a limited amount of inorganic particles. If inorganic particles are used, the rubbing effect can be reduced by introducing the marked particles in a downstream feeding process. In another embodiment, the plastic does not contain inorganic particles and any chromophore(s) in the plastic are organic dyes or pigments.

Optionally, the tagged polymer compositions can comprise chromophore(s) as a further security feature, and/or to attain a sparkling and/or metallescent appearing product. These chromophore(s), for example, could impart a specific appearance to the tagged polymer/article under normal lighting conditions (e.g., daylight), and a different appearance under other lighting conditions (e.g., ultraviolet (UV) light). Chromophores include but are not limited to, the following families: anthraquinones, methine, perinones, azo, anthrapyridones, quinophtalones, indanthrones, pyranthrones, benzimidazolones, quinacridones, perylenes, pyranthrones, diketopyrrolo-pyrrole (DPP) pigments, dibromanthrones, dioxazines, phthalocyanines, inorganic pigments, and luminescent compounds, and the like, as well as combinations comprising at least one of the foregoing chromophores. Inorganic pigments include white pigments (e.g., TiO₂, ZnO, BaSO₄, and the like), colored metal oxides (e.g., iron oxides, chromium oxides, and the like), mixed metal oxides (e.g., cobalt titanate pigments, and the like), ultramarines and cerium sulfide pigments, and the like, as well as combinations comprising at least one of the foregoing. Luminescent compounds include an organic fluorophore, an inorganic fluorophore, an organometallic fluorophore, a phosphorescent material, a luminescent material (e.g., luminescent conjugated polymers such as blue emitting luminescent polymers (e.g., poly-paraphenylenevinylene derivatives, and the like)), semiconducting luminescent nanoparticle, and the like, as well as combinations comprising at least one of the foregoing. The chromophores can be used individually or in combinations.

Fluorophores include long stokes shift fluorophore, and others. Examples of fluorophore tags include organic, inorganic, or organometallic fluorophores, such as dye families exhibiting fluorescent properties, such as polyazaindacenes and coumarins, and including those set forth in U.S. Pat. No. 5,573,909. Fluorophores also include anti-stokes shift pigments which absorb in the near infrared wavelength and emit in the visible wavelength. Fluorophore tags may also include luminescent nanoparticles of having a length of about 1 nanometer to about 50 nanometers, as measured along the major axis. Exemplary luminescent nanoparticles include, but are not limited to, semi-conducting nanoparticles of CdS, CdSe, ZnS, ZnSe, Cd₃P₂, PbS, PbSe and as well as combinations comprising at least one of the foregoing. Other luminescent nanoparticles also include rare earth aluminates and silicates including, but not limited to, strontium aluminates doped with europium and/or dysprosium.

Dyes include lanthanide complexes, hydrocarbon and substituted hydrocarbon dyes; polycyclic aromatic hydrocarbons; scintillation dyes (preferably oxazoles and oxadiazoles); aryl- and heteroaryl-substituted polyolefins (C2-C8 olefin portion); carbocyanine dyes; phthalocyanine dyes and pigments; oxazine dyes; carbostyryl dyes; porphyrin dyes; acridine dyes; anthraquinone dyes; anthrapyridone dyes; arylmethane dyes; azo dyes; diazonium dyes; nitro dyes; quinone imine dyes; tetrazolium dyes; thiazole dyes; perylene dyes; perinone dyes; bis-benzoxazolylthiophene (BBOT); naphthalimide dyes; benzimidazole dyes; indigoid and thioindigoid dyes; xanthene and thioxanthene dyes, and the like, as well as derivatives and combinations comprising at least one of any of the foregoing chromophores.

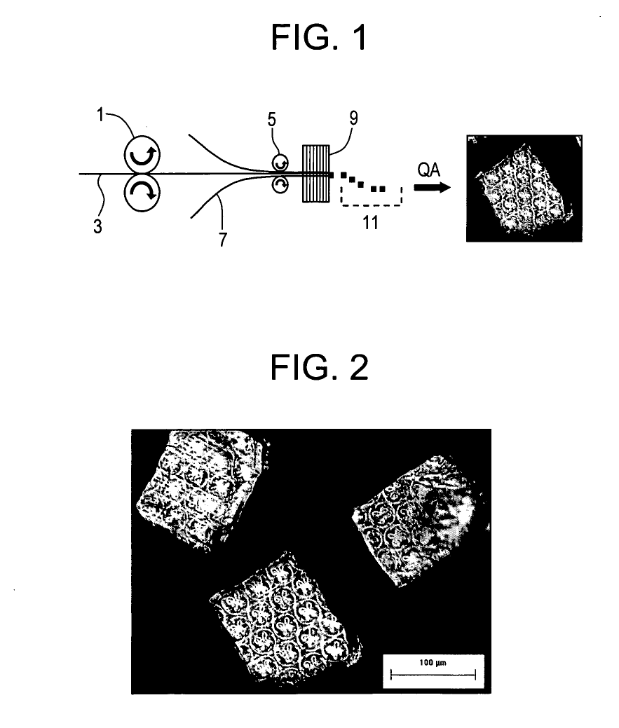

FIG. 1 is a schematic illustration of one embodiment of a process used for making micro-embossed particles (e.g., aluminum flakes). Initially, an embossing roll can be formed with the desired micro-embossing pattern. For example, the information to be micro-embossed can be converted into digital information that is utilized to transfer the desired pattern to a nickel embossing roll element 1. Several methods can be used to prepare the embossing roll element 1 including photomasking followed by electroforming of the nickel element 1 (as generally used in the making of holographic patterns), embossing with a laser such that the pattern is etched into the roll element, and/or the like. For example, the element 1 can be embossed using a high intensity laser, etching the element and forming the pattern with an embossing depth of about 0.15 micrometers to about 0.2 micrometers. The pattern from the embossing elements 1 can then be transferred to one or both sides of a foil 3 (e.g., to both sides of a 16 micrometer thick aluminum foil polished on both sides). A protective coating 7 can be applied over the embossed foil, e.g., by thermally sealing 5 (such as via a hot lamination process) a film 7 (e.g., an about 12 micrometer thick, bi-axially stretched, film) to one or both sides of the embossed foil. The multi-layered film (thermoplastic/aluminum/thermoplastic) can then be cut into particles. For example, the foil can be fed to a high precision rotary cutter 9 (e.g., that can cut to a size as small as about 50 micrometers by 50 micrometers, with a tolerance of less than or equal to 5 micrometers), e.g., at an appropriate angle. The knives and blades dimensions in the rotary cutter are selected to yield the desired size and shape at a given cutter rotation speed. After the cutting, the particles can be screened 11 to remove improperly cut particles (e.g., two particles bound together, smaller/larger particles than desired specifications, and/or the like).

Other tags can be employed to form additional security layers in addition to the micro-embossed flakes. Such tags include molecules and materials that can be identified using an analytical technique such as spectroscopy techniques like Raman, infrared, XPS, UV, Visible, NIR and fluorescence spectroscopy; resonance techniques like NMR or ESR; X-ray analysis including X-ray diffraction X-ray scattering and X-ray fluorescence; and microscopy techniques in the case of forensic tags such as nano-barcodes made from inorganic nanofibers containing unique sequences of materials with different optical reflectivity. Tags may also include flakes or pigments with paramagnetic or super-paramagnetic properties, layered flakes or pigments, interference flakes or pigments, and combinations comprising at least one of the foregoing.

Incorporation of the micro-embossed particles containing the identifier into the thermoplastic resin is performed so as to retain the identifier; i.e., because the identifier could be erased by mechanical abrasion during extrusion, abrasion (or “rubbing” effect) is minimized. For example, the micro-embossed particles can be incorporated into the resin using a downstream feeding process at the extruder to limit abrasion of the particle surface and also to decrease the probability of damage to particles (e.g., folding, bending, or tearing) due to shear. The particles can be added to the resin as dry pigment, in dispersion, and/or with a carrier (for example using a wax, mineral oil, or a resin carrier). In an embodiment of a downstream feeding process, the extruder screw and the downstream port are designed such that the embossed particles will not be in contact with kneading blocks (KB). In another embodiment of a downstream feeding process, the extruder screw and the downstream ports are designed such that the embossed particles will not be in contact with kneading blocks (KB) or aggressive mixing elements, such as ZME elements.

A masterblend and/or masterbatch (e.g., a concentrate) of the tagged particles can be used and added directly to the extruder (e.g., at the throat or to a downstream port) and/or to the molding machine or extrusion line with the proper feeding system to control the actual loading of tagged particles added to the composition. The concentrate can be formed by addition of the particles to the resin carrier optionally with the help of dispersing agent(s), stabilizer(s), and/or rheology modifier(s). The particle loading of the concentrate can be selected so that it is in the appropriate range for a side feeder for a given particle loading in the final resin composition. The particle loading of the concentrate can be less than or equal to about 85 weight percent (wt %), more specifically, about 10 wt % to about 60 wt %, even more specifically, about 15 to about 50 wt %, and even more specifically about 20 wt % to about 40 wt %, based on a total weight of the concentrate. The concentrate simplifies obtaining a desired final loading of the tagged particle in the resin or article. The loading of the tagged particle in the resin or final article is dependent upon the authentication method and system and also upon the desired appearance (e.g., a higher particle loading can be used to attain a “metallic” look vs. a “sparkle” look). Sufficient particles are disposed in the resin/article to enable the desire authentication accuracy and efficiency. A final particle loading can be about 0.01 wt % to about 5 wt %, more specifically, about 0.05 wt % to about 3 wt %, and even more specifically, about 0.1 wt % to about 1 wt %, based upon the total weight of the resin/article.

One method of detection of the tags (e.g., markings, natural features, particle shape, and the like), is microscopy. Optical microscopes such as a typical metallurgical microscope with reflectance mode lighting are quite effective. For example, the micrographs shown in FIGS. 1 and 2 below were taken using an Olympus BX60 microscope w/ a 20× objective, a 10× ocular eyepiece, and a 2× multiplier, for a total of 400× magnification. Use of a digital camera attached to the microscope allows for further digital enlargement of the embossed feature. In addition to bright field illumination, other lighting techniques can be used to enhance imaging of the micro-embossed features, including darkfield, phase contrast, differential interference contrast, and polarizers. The ability to control and/or adjustment of brightness is critical since the specular reflection of embossed metallic particles can mask the micro-embossed features. In addition to traditional optical microscopes, handheld/portable digital microscopes such as the ProScope USB Microscope M2 or the Scalar DG-2 devices fitted with a 400× or a 500× lens can also be used to view the micro-embossed features on the particle surface. In order to effectively be able to use the digital microscopes, it is important to have a solid stand so that the scope can be firmly held in place. In some instances, it may be desirable to use a stand in combination with micrometric positioning systems to precisely move the sample in order to better control the location of the observed area and allow for easier focusing.

### EXAMPLES

### Example 1

### One Embodiment of Flake Preparation is Disclosed

As an illustration of the types of particles that can be formed, square-cut and hexagonal-cut flakes were obtained by using the process illustrated in FIG. 1 to cut an aluminum foil that was first micro-embossed with multiple miniature GE logos (i.e., a non-coded identifier that is easily identifiable by a wide varieties of third parties without special training) and subsequently laminated with PET films on both sides. FIG. 2 illustrates square die-cut flakes, while FIG. 3 illustrates hexagonal die-cut flakes. The logos (each about 25 micrometers in size) were not visible to the naked eye (were covert). A minimum magnification of about 400× was required to clearly identify the markings on the flakes. Marking the flakes with such a small identifier ensures a covert nature of the marking in the original flake, rendering the flake useful for security applications.

EXAMPLE 2 Illustrates that the Particle is not Apparent upon Macroscopic Level Viewing.

A GE Cycoloy® PC/ABS VisualFX™ Sparkle color (commercially available from GE Plastics, Pittsfield, Conn.) using ball-milled flake was produced (FIG. 3) using twin screw extrusion process and throat-feeding all the formulation ingredients. The part was then color matched using 50% of the micro-embossed flake in place of ball-milled aluminum flake to produce the hexagonal sample part shown in FIG. 4. The total loading of aluminum (Al) flake was 1 wt %, based upon the total weight of the sample, in both samples.

FIG. 5 shows the GE Logo features in the part containing the micro-embossed flake. Although the GE logo is somewhat visible at 400× magnification, the surface is noticeably worn due to wear of the surface of the flake resulting from the extrusion and molding processes. Identification of the sample becomes more difficult and less accurate when a sample cannot be clearly identified. An inability to produce clearly identifiable samples also enables counterfeiters to claim authenticity with a worn counterfeited sample. This sample is believed to have a embossing depth after processing of less than 25%.

EXAMPLE 3 Illustrates that Downstream Feeding of the Flakes Improves the Structural Integrity of the Flakes and Enables Facile, Accurate Authentication.

In order to improve the distinctness of the micro-embossing image, a GE Cycoloy® PC/ABS sample containing micro-embossed flakes was produced by minimizing wear of the surface of the flake. This improved result, shown in FIG. 6, was achieved using downstream feeding of the micro-embossed flake, and throat feeding of the polycarbonate (although the polycarbonate could be feed through an upstream port). In this example, a powder blend mixture containing 30 wt % micro-embossed flakes and 70 wt % high flow Lexan® polycarbonate powder was fed into the extrusion process downstream. The logos were noticeably more distinct than in Example 2.

EXAMPLE 4 Illustrates the Addition of Multiple Security Tags (e.g., a Marked Particle with a Coating Including a Chromophore)

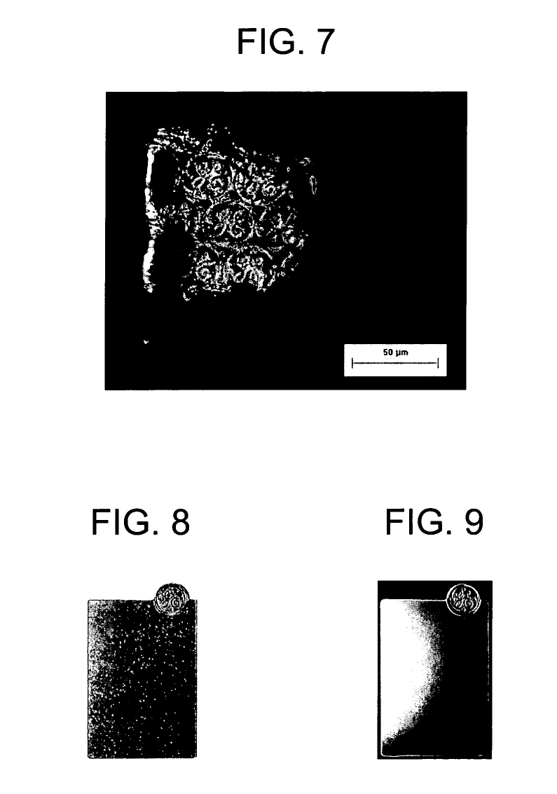

Although incorporation of micro-embossed flakes alone can be used as a technique to provide security tagging in engineering thermoplastics, an approach using multiple types of authentication enhances accuracy. The part shown in FIGS. 7 and 8 contains a fluorophore in addition to the micro-embossed flakes. FIG. 8 was taken upon illumination with a UV lamp. Under standard lighting conditions (daylight, office lighting, etc.), the part is blue in color (FIG. 7). Upon exposure to a UV lamp, the part glows light green in color.

Security features can be employed in numerous industries; from the music industry to the automotive industry, from telecom equipment/accessories to consumer electronics, and from banking to personal identification documents to resin compositions. Some exemplary products that can employ the marked particles include, thermoplastic resin particles, computers and computer accessories (e.g., notebook cover, monitor, printer cover, inkjet/toner cartridge, mouse, keyboard, and the like), cellular phone accessories (e.g., phone cover, phone body, batteries, battery covers, and the like), identification cards and tags (e.g., driver's license, badges, security tags, and the like), drug containers, medical devices, wines and spirituals containers (e.g., bottles, bottle caps, and the like), packaging, automotive parts and accessories, and the like. In all of these areas, and others, the ability to achieve accurate authentication is constantly sought. The use of the particles enables a new level of security. Additionally, including identifiers within identifiers (e.g., multilevel), incorporating additional taggants (e.g., a colored coating on the particles, a colored resin in which the particles are dispersed, a particular particle shape, a natural particle feature (e.g., a part of the crystal structure, color effect (e.g., marbleized), intentional “defect”, or the like), and the like), as well as combinations comprising at least one of the foregoing, enables greater authentication accuracy and a larger barrier to counterfeiting. For example, a data storage media (e.g., a first surface and near-field media, CD, DVD, DVR, or the like, e.g., disposed in a non-read area of an optical media), a credit or bank card, or the like, can comprise a substrate with a chromophore, with particles dispersed either throughout the substrate or in predetermined locations (wherein the location itself is an authentication identifier), wherein the particle is micro-embossed with a two layer identifier; one visible at a first magnification and a second only visible at a higher magnification, and the particle is encapsulated in a polymer (e.g., thermoset material) that also comprises a particular chromophore.

Considering the processing of many thermoplastic resins (e.g., molding, twin-screw extruding, and/or the like), and considering that particle design (e.g., the particle is very thin (e.g., less than or equal to about 50 micrometers), and the identifier may only cut into the surface of the particle a small amount (e.g., about 0.2 micrometer of embossing depth), it was very unexpected that particles retaining the complete identifier remained after processing.

An additional benefit of the use of the marked particles disclosed herein is that they are less prone to flow lines because of their extremely low aspect ratio. Even standard flakes (non-marked) produced commercially do not have such a low aspect ratio for this kind of size; they generally have an aspect ratio of greater than 20:1, while the present flakes can have an aspect ratio of about 1:1 to about 5:1 for flake sizes of about 50 to about 150 micrometers. Additionally, by forming the particles using precision cutting (e.g., with a tolerance such that greater than or equal to about 99% of the particles have a nominal size ±5 micrometers), a narrow particle size distribution can be obtained. Grinding, a non-precision method, produces a broad particle size distribution.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A tagged resin, comprising:
a thermoplastic material; and
a marked particle, wherein the marked particle comprises a covert identifier, wherein the particle has a median length of about 20 micrometers to about 350 micrometers, as measured along a major axis, and has an aspect ratio of about 1:1 to about 10:1.

2. The tagged resin of claim 1, wherein the aspect ratio is about 1:1 to about 5:1.

3. The tagged resin of claim 2, wherein the median length is about 50 micrometers to about 100 micrometers.

4. The tagged resin of claim 1, wherein the marked particle further comprises a protective coating over the covert identifier.

5. The tagged resin of claim 4, wherein the protective coating comprises a chromophore.

6. The tagged resin of claim 5, wherein the chromophore is a fluorophore.

7. The tagged resin of claim 1, wherein the marked particle comprises at least two levels of marking that are not visible to the naked eye, wherein a first level of marking is visible at a first magnification, and wherein a second level of marking is not visible at the first magnification and is visible at a second, stronger magnification.

8. The tagged resin of claim 7, wherein the first magnification is about 100× to about 400×, and wherein the second, stronger magnification is greater than or equal to about 500×.

9. The tagged resin of claim 1, wherein the marked particle further comprises a feature,
wherein the covert identifier is selected from the group consisting of a coded identifier, a non-coded identifier, multilevel identifier, and combinations comprising at least one of the foregoing identifiers; and
wherein the feature is selected from the group consisting of a protective coating comprising a chromophore, a particle shape, an intentional particle defect, a particle composition, a coating material with a tag in a polymer chain, and combinations comprising at least one of the foregoing features.

10. The tagged resin of claim 1, wherein the covert identifier is disposed on a surface having a Ra of less than or equal to about 0.025 micrometers.

11. The tagged resin of claim 10, wherein the Ra is less than or equal to about 0.015 micrometers.

12. The tagged resin of claim 1, wherein the covert identifier is disposed on a surface having a Ra, and wherein a ratio of Ra to marking depth is less than or equal to about 15%.

13. The tagged resin of claim 12, wherein the ratio is less than or equal to about 10%.

14. The tagged resin of claim 13, wherein the ratio is less than or equal to about 5%

15. The tagged resin of claim 14, wherein the ratio is less than or equal to about 1%.

16. The tagged resin of claim 1, wherein the thermoplastic material and the marked particle have been processed by a method selected from the group consisting of extruding, thermoforming, blow-molding, injection molding, and combinations comprising at least one of the foregoing methods.

17. The tagged resin of claim 1, wherein the thermoplastic material with the marked particle exhibits 100% ductility at 23° C., according to ASTM D256 using a 3.2 mm thick sample.

18. The tagged resin of claim 17, wherein the thermoplastic material with the marked particle exhibits 100% ductility at 0° C., according to ASTM D256 using a 3.2 mm thick sample.

19. The tagged resin of claim 18, wherein the thermoplastic material with the marked particle exhibits greater than or equal to about 40% ductility at −20° C., according to ASTM D256 using a 3.2 mm thick sample.

20. A method for making a tagged item, comprising:
processing a thermoplastic material and a marked particle to form a processed item, wherein the processing is selected from the group consisting of extruding, injection-molding, masterbatching, masterblending, thermoforming, blow-molding, and combinations comprising at least one of the foregoing processing;
wherein the marked particle in the processed item comprises an aspect ratio of about 1:1 to about 10:1 and a covert identifier.

21. The method of claim 20, wherein the aspect ratio is about 1:1 to about 5:1.

22. The method of claim 20, wherein the covert identifier is disposed on a surface having a Ra of less than or equal to about 0.025 micrometers.

23. The method of claim 20, wherein the marked particle further comprises a ratio of Ra to marking depth of less than or equal to about 15%.

24. The method of claim 20, further comprising forming the marked particle by:
micro-embossing a foil with a mark to form a marked foil; and
cutting the marked foil.

25. The method of claim 20, further comprising disposing a coating on the marked particle, wherein the coating at least covers the covert identifier.

26. The method of claim 25, wherein disposing the coating further comprises:
forming a suspension of the marked particle and a coating material;
adding the suspension to an aqueous mixture comprising a suspension agent to form a reaction mixture;
heating and mixing the reaction mixture to form a coated particle;
quenching the reaction mixture after the coated particle is formed; and
collecting the coated particle.

27. The method of claim 20, further comprising forming a concentrate of marked particles, wherein the concentrate is selected form the group consisting of a masterbatch, a masterblend, and a combination comprising at least one of the foregoing concentrates.

28. The method of claim 27, further comprising introducing the concentrate to a downstream port of an extruder and introducing the thermoplastic material to at least one of a throat and an upstream port of the extruder.

29. The method of claim 28, wherein the concentrate does not contact a kneading block of the extruder.

30. The method of claim 27, further comprising molding the concentrate and the thermoplastic material.

31. The method of claim 20, wherein the identifier comprises forensic information.

32. The method of claim 20, wherein the processing is selected from the group consisting of masterbatching, masterblending, and combinations comprising at least one of the foregoing processing.

33. The method of claim 20, wherein the processing comprises extruding.

34. The method of claim 33, wherein the processed item is a thermoplastic pellet.

35. The method of claim 20, wherein the processing is selected from the group consisting of injection-molding, thermoforming, blow-molding, and combinations comprising at least one of the foregoing processing.
